(19) United States
(12) Patent Application Publication
(10) Pub. No.: US 2013/0095819 A1
(43) Pub. Date: Apr. 18, 2013

(54) METHOD AND APPARATUS FOR PERFORMING NEIGHBORING CELL MEASUREMENTS IN WIRELESS NETWORKS

(71) Applicants: Steven D. Cheng, San Diego, CA (US); Guangming Shi, San Diego, CA (US); Kuo-Chun Lee, San Diego, CA (US); Tom Chin, San Diego, CA (US)

(72) Inventors: Steven D. Cheng, San Diego, CA (US); Guangming Shi, San Diego, CA (US); Kuo-Chun Lee, San Diego, CA (US); Tom Chin, San Diego, CA (US)

(73) Assignee: QUALCOMM Incorporated, San Diego, CA (US)

(21) Appl. No.: 13/276,249

(22) Filed: Oct. 18, 2011

(51) Int. Cl. H04W 24/00

(52) U.S. Cl. 455/424

(57) ABSTRACT

Methods and apparatuses are provided that include selecting measurement types for measuring neighboring cells based in part on a change in device location. Where a change in location is relatively small, a device can perform less precise more efficient measurements of the neighboring cells to conserve power and/or processing time than where the change in location is larger. The neighboring cells can operate on a difference frequency than a serving cell; thus, measuring the neighboring cells using more precise measurements can utilize radio frequency (RF) calibration over the different frequency. Where a change in device location is below a threshold, however, less precise measurements that do not use RF calibration can be utilized to measure the neighboring cells.

### BACKGROUND

1. Field

The following description relates generally to wireless network communications, and more particularly to measuring neighboring cells.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP) (e.g., 3GPP LTE (Long Term Evolution)/LTE-Advanced), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth.

In addition, in some wireless communication technologies, such as WiMAX, LTE, etc., devices can perform measurements of base stations other than a source or serving base station to determine when communications are improved at the other base stations. This information can be used for mobility at the device (e.g., to cause the device to handover communications to the other base stations). The device can perform such measurements across radio access technologies as well, which can include measuring base stations over frequencies other than a current operating frequency of the device. Moreover, the device typically performs signal-to-noise ratio, carrier-to-interference-and-noise-ratio, or similar types of measurements that require radio frequency calibration at the device for measuring substantially all neighboring cells including those using different operating frequencies. Such calibration can impact power consumption and processing time at the device.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, the present disclosure describes various aspects in connection with reducing power consumption caused by measuring signals from neighboring cells. For example, a device can select a type of measurement to utilize in measuring neighboring cells based on a determined change in location of the device. Thus, where the change in location of the device results in a similar radio communications environment, measurements that utilize radio frequency (RF) calibration, such as signal-to-noise ratio (SNR), carrier-to-interference-and-noise ratio (CINR), etc., may not be needed. In this example, the device can utilize other less precise but more efficient measurements, such as received signal strength indicator (RSSI), to measure neighboring cells. The change in location can be inferred or otherwise determined according to a change in a measurement result related to a serving base station, a global positioning system (GPS) measured location change, other location-assisted methods, and/or the like, and can be measured against one or more thresholds to select the measurement type.

According to an example, a method for measuring neighboring cells in wireless communications is provided. The method includes determining to measure signals from one or more neighboring cells and determining a change in location since a previous measurement. The method further includes selecting a measurement type for measuring the signals based at least in part on the change in location.

In another aspect, an apparatus for measuring neighboring cells in wireless communications is provided that includes means for determining to measure signals from one or more neighboring cells and means for determining a change in location since a previous measurement. The apparatus further includes means for selecting a measurement type for measuring the signals based at least in part on the change in location.

In yet another aspect, an apparatus for measuring neighboring cells in wireless communications is provided. The apparatus includes at least one processor configured to determine to measure signals from one or more neighboring cells and determine a change in location since a previous measurement. The at least one processor is further configured to select a measurement type for measuring the signals based at least in part on the change in location. The apparatus also includes a memory coupled to the at least one processor.

Still, in another aspect, a computer-program product for measuring neighboring cells in wireless communications is provided including a non-transitory computer-readable medium having code for causing at least one computer to determine to measure signals from one or more neighboring cells and code for causing the at least one computer to determine a change in location since a previous measurement. The computer-readable medium further includes code for causing the at least one computer to select a measurement type for measuring the signals based at least in part on the change in location.

Moreover, in an aspect, an apparatus for measuring neighboring cells in wireless communications is provided that includes a signal measuring component for determining to measure signals from one or more neighboring cells and a location change determining component for determining a change in location since a previous measurement. The apparatus further includes a measurement type selecting component for selecting a measurement type for measuring the signals based at least in part on the change in location.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of an aspect of a system for measuring neighboring cells.

FIG. 2 is a block diagram of an aspect of a system for selecting measurement types for measuring neighboring cells based on a change in location.

FIG. 3 is a block diagram of an aspect of a system for measuring neighboring cells according to a change in location.

FIG. 4 is a flow chart of an aspect of a methodology for selecting measurement types for performing measurements of neighboring cells.

FIG. 5 is a flow chart of an aspect of a methodology for selecting measurement types for measuring neighboring cells based on a serving cell signal quality.

FIG. 6 is a block diagram of an aspect of an example system that selects measurement types for performing measurements of neighboring cells.

FIG. 7 is a block diagram of an aspect of an example mobile device in accordance with aspects described herein.

FIG. 8 is a block diagram of an aspect of a wireless communication system in accordance with various aspects set forth herein.

FIG. 9 is a schematic block diagram of an aspect of a wireless network environment that can be employed in conjunction with the various systems and methods described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, a device can select measurement types for performing measurements of one or more neighboring cells based on a determined change in location of the device. For example, the change in location can relate to a current location as compared to a location during a time period of a previous measurement. For example, where the change in location is below a threshold, this can indicate that measurements of the neighboring cells may not have changed much, and thus imprecise measurements can be utilized to update a neighbor list.

For example, where the change in location is above a threshold, the device can perform more precise measurements of the neighboring cells, such as measurements utilizing radio frequency (RF) calibration (e.g., signal-to-noise ratio (SNR), carrier-to-interference-and-noise-ratio (CINR), etc.). Where the change in location is below a threshold, however, the device can perform less precise measurements of the neighboring cells, such as received signal strength indicator (RSSI), or similar measurements, which utilize less power and/or processing time than the more precise measurements. In this regard, power consumption and/or processing time can be conserved when performing measurements of the neighboring cells.

As used in this application, the terms “component,” “module,” “system” and the like are intended to include a computer-related entity, such as but not limited to hardware, firmware, a combination of hardware and software, software, or software in execution, etc. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE), etc. A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, a tablet, a smart book, a netbook, or other processing devices connected to a wireless modem, etc. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE/LTE-Advanced and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

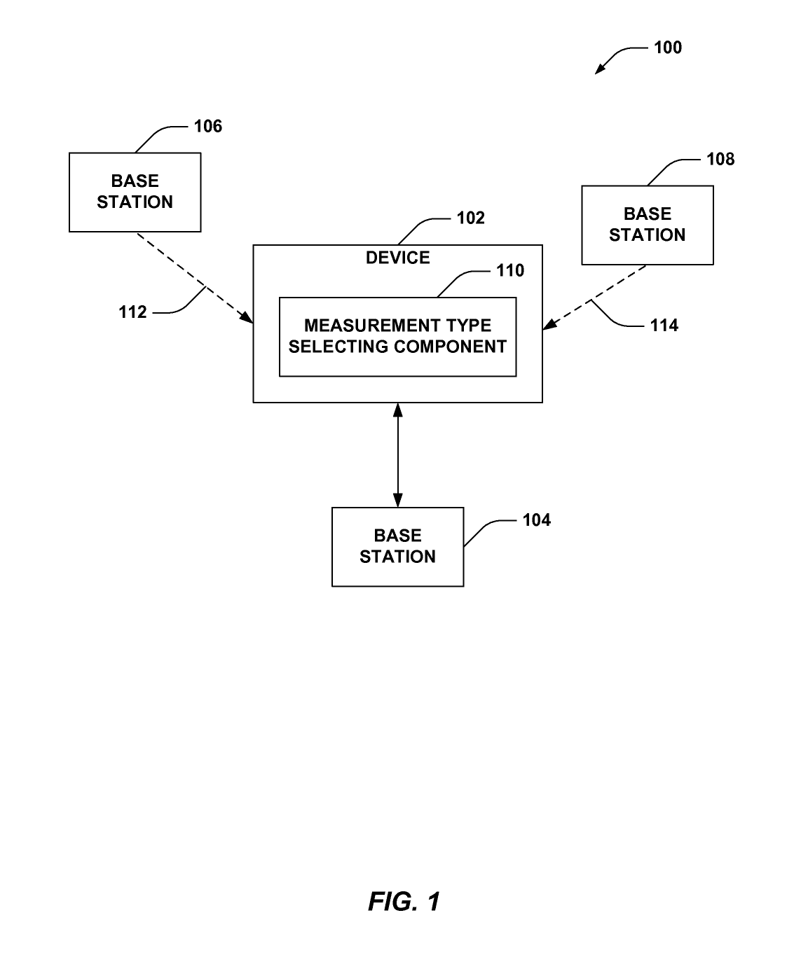

FIG. 1 illustrates an example system 100 for measuring signals of neighboring cells while communicating with a serving base station. System 100 comprises a device 102 that communicates with a base station 104 to receive wireless network access. System 100 also comprises base stations 106 and 108 which can provide neighboring cells from which device 102 can measure signals. Device 102 can be a UE, modem (or other tethered device), a relay (e.g., UE relay), a portion thereof, and/or substantially any device that measures signals from one or more base stations. Base stations 104, 106, and 108 can each be a macrocell base station, a femto node, a pico node, a micro node, or similar base station, a relay, a mobile base station, a device (e.g., communicating in peer-to-peer or ad-hoc mode with device 102), a portion thereof, and/or the like. In addition, device 102 can comprise a measurement type selecting component 110 for determining measurement types for measuring signals from neighboring cells.

According to an example, device 102 can communicate with base station 104 in a serving cell provided by the base station 104. A cell can correspond to an area of coverage of a base station. For example, the base station transmits signals at a power to reach devices at a threshold signal quality within a geographic area defined by the cell. In addition, base station 104 and other base stations can provide multiple cells. Device 102 can be handed over among various cells to provide seamless wireless network access as the device 102 moves throughout the wireless network. Base stations 106 and 108 can also provide cells from which device 102 can receive signals; such cells, and other cells of base station 104, are referred to herein as neighboring cells of the serving cell. Device 102 periodically measures neighboring cells to determine an appropriate time to handover communications from the serving cell to a neighboring cell (e.g., when a signal quality in the neighboring cell exceeds or is at least within a threshold difference of that of the serving cell). The device 102 can store measurements in a neighbor list for device-initiated handover and/or can report measurements in a measurement report to base station 104 for network-initiated handover.

In many cases, the device 102 can measure the neighboring cells of base stations 106 and 108 using measurement types that utilize RF calibration to the neighboring cells, such as SNR, CINR, etc. This can be the case, moreover, where the base stations 106 and 108 operate on a different frequency and/or different radio access technology (RAT) as base station 104. For example, a receiver of the device 102 may be tuned to the operating frequency of the cells to perform measurements, which can cause RF calibration of the receiver to synchronize with the operating frequency. Such measurements, however, may not always be necessary, especially in cases where a change in location of device 102 (e.g., and thus likely a change in radio conditions) between time periods of measuring is below a threshold. In this regard, measurement type selecting component 110 can select a measurement type for measuring one or more neighboring cells in a given time period based on a determined change in location.

For example, the change in location can be determined or inferred based on a measurement result of serving base station 104, a GPS location, other location-assisted methods, which can include satellite-based methods (e.g., GPS, global navigation satellite system (GLONASS), compass navigation system, Galileo positioning system, etc.), terrestrial-based methods (e.g., observed time difference of arrival (OTDOA), enhanced cell identifier (E-CID), etc.), and/or the like. Where the change in location is below a threshold, measurement type selecting component 110 can select a measurement type that is more efficient and perhaps less precise than a typical measurement type for measuring neighbor cells (e.g., RSSI). Such measurements can suffice since the radio conditions of device 102, by virtue of the determined change in location, have also not changed much since a previous measurement. Thus, power consumption and/or processing time can be conserved at device 102.

Where the change in location is above a threshold, however, measurement type selecting component 110 can select a measurement type that is more precise, such as SNR, CINR, etc. to measure neighboring cells of base stations 106 and 108. Measurement type selecting component 110 can improve power consumption and/or processing time related to these measurements as well by determining to first perform more efficient measurements of the neighboring cells to determine a subset of strongest cells (e.g., those cells with signal measurements over a threshold RSSI, a number of top cells with highest RSSI, etc.), and then to perform the more precise less efficient measurements over the subset of strongest cells. As described, the measurements, in either case, can be used to update a neighbor list for device-initiated handover and/or in a measurement report transmitted from device 102 to base station 104 for network-initiated handover.

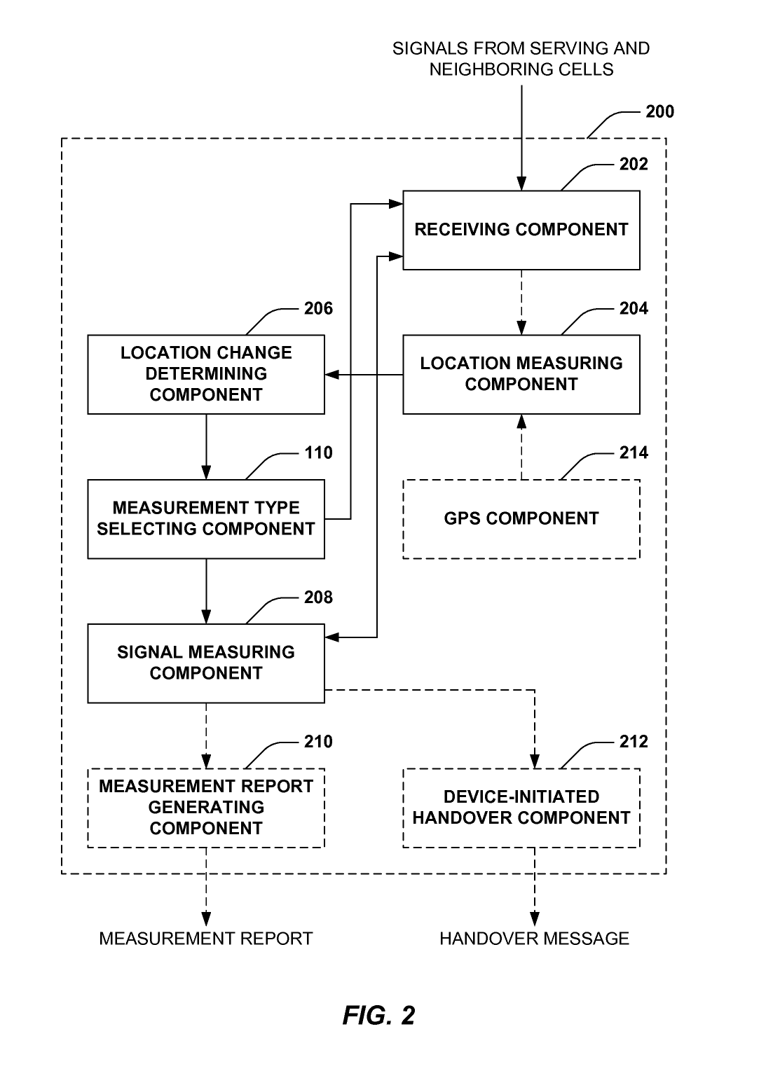

FIG. 2 illustrates an example apparatus 200 for selecting measurement types for measuring neighboring cells based on a determined change in location. Apparatus 200 can be a device, as described above, receiving access to a wireless network from one or more base stations (not shown). Apparatus 200 can measure neighboring cells during one or more time periods to evaluate the cells for handover or otherwise include the cells in a measurement report, as described.

Apparatus 200 includes a receiving component 202 for receiving signals from a serving cell and/or neighboring cells, a location measuring component 204 for determining one or more location parameters, and a location change determining component 206 for obtaining a change in location based on the one or more location parameters. Apparatus 200 further includes a measurement type selecting component 110 for determining a measurement type to utilize in measuring neighboring cells based in part on the change in location, and a signal measuring component 208 for performing the measurements of the neighboring cells. Apparatus 200 also optionally comprises a measurement report generating component 210 for creating or updating a measurement report based on the measurements, a device-initiated handover component 212 for generating a handover message based on neighbor list measurements, and/or a GPS component 214 for determining a GPS or other satellite-based position.

According to an example, signal measuring component 208 can measure signals of a serving cell and one or more neighboring cells using receiving component 202 to obtain signals therefrom. For example, signal measuring component 208 can perform various types intra- or inter-frequency measurements using receiving component 202; this can include tuning receiving component 208 to a frequency other than an operating frequency to perform inter-frequency measurements. In addition, signal measuring component 208 can utilize the receiving component 208 to perform more precise measurements that use RF calibration (e.g., SNR, CINR, etc.) at the receiving component 202, as well as more efficient but less precise measurements (e.g., RSSI). In an example, signal measuring component 208 can determine to perform measurements based on a timer or other event or trigger, such as detecting interference, detecting a rise in thermal noise, receiving an indication from a base station to measure neighboring cells, etc. Measurement type selecting component 110 can select types of measurements for signal measuring component 208 to perform of one or more neighboring cells in a given time period. As described, this can be based on a change in location of apparatus 200 since a previous measurement.

In an example, location measuring component 204 can determine one or more location parameters related to apparatus 200. In one example, location measuring component 204 can receive signals from a serving cell and/or one or more neighbor cells, determine a measurement result thereof, much like signal measuring component 208, and base the location of apparatus 200 on the measurement result. Location measuring component 204 can provide the measurement result(s) to location change determining component 206, which can determine or otherwise infer a change in location of apparatus 200 based in part on the measurement result(s). In one example, the change in location can be based on a comparison of the measurement results.

For example, where location change determining component 206 detects a measured signal quality at the serving cell is below a quality that causes a handover to a neighboring cell (e.g., a downlink channel descriptor (DCD) handover (HO) value in WiMAX), this can indicate the apparatus 200 is no longer near enough to the serving cell to receive access therefrom. In this example, location change determining component 206 can infer a change in location sufficient to cause measurement type selecting component 110 to select more precise measurement types (e.g., a precise measurement type such as SNR, CINR, etc.) for measuring neighboring cells. Where location change determining component 206 detects a signal quality above the quality at which handover can be triggered, location change determining component 206 can determine less of a change in location, and thus measurement type selecting component 110 can select more efficient less precise measurement types (e.g., an efficient measurement type such as RSSI) for measuring neighboring cells. Similarly, where location change determining component 206 detects a signal quality of a neighboring cell at least a threshold level above that of the serving cell, location change determining component 206 can similarly determine a change in location over a threshold or otherwise determined such that measurement type selecting component 110 selects a more precise measurement type.

In another example, location change determining component 206 can compare the measurement result(s) to previous measurements obtained in a previous or last time period. For example, where a difference between the measurement results and those of the previous time period is below a threshold, this can indicate that the change in location of the apparatus 200 is small. For example, location measuring component 204 can obtain a measurement result of a serving base station. Location change determining component 206 can compare the measurement result to a previous measurement of serving base station (e.g., in a previous time period, which can be a time period where measurements of other neighboring cells are performed). Where the measurement result and previous measurement are similar or at least within a threshold difference, location change determining component 206 can determine and/or indicate less of a change in location, which can cause measurement type selecting component 110 to determine to perform more efficient, less precise measurements of neighboring cells (e.g., RSSI measurements).

It is to be appreciated that the location change determining component 206 can provide the change in location as an indicator whether the change is sufficient for more precise measurement and/or more efficient measurement. In another example, the change in location can correspond to a numeric value or other parameter, such as the handover threshold subtracted from a serving cell signal quality, neighboring cell measurements from location measuring component 204 subtracted from serving cell measurements (also from location measuring component 204), and/or the like. In this example, measurement type selecting component 110 can determine the measurement type based on the numeric value, which can include comparing the value to one or more ranges of values that indicate whether to perform certain types of measurements corresponding to the ranges (e.g., more precise or more efficient measurements, specific types of measurements, and/or the like). In addition, measurement type selecting component 110 can determine the measurement type based on additional factors or parameters, such as a communication mode of apparatus 200 (e.g., active mode, idle mode, etc.), a period of time available for performing measurements, and/or the like.

Moreover, for example, where signal measuring component 208 has not yet measured neighboring cells using the more precise measurements (e.g., SNR, CINR, etc.), measurement type selecting component 110 can select the more precise measurement type for initial neighboring cell measurements. For example, signal measuring component 208 can store one or more measurements in a neighbor list or measurement report, and can thus determine whether to perform the more precise measurements further based on whether signal measuring component 208 has stored such measurements. For instance, if no measurements are stored, measurement type selecting component 110 can determine to perform more precise measurements regardless of the change in location received from location change determining component 206.

In addition, in an example, where measurement type selecting component 110 determines to perform more precise measurements (e.g., where the change in location is sufficient for such, as described), this can include selecting two types of measurements: 1) an initial efficient (e.g., RSSI) measurement performed by signal measuring component 208 to determine a subset of neighboring cells having a signal quality at least at a threshold; and 2) a subsequent more precise (e.g., SNR, CINR, etc.) measurement over the subset of neighboring cells. Signal measuring component 208 can perform the selected measurements, which can conserve power since the more precise measurements possibly using RF calibration at the receiving component 202 are performed for cells that are above the threshold signal quality and not necessarily other cells.

In any case, the signal measurements, whether more precise or more efficient, can be utilized to update a measurement report and/or a neighbor list. Thus, in one example, measurement report generating component 210 can obtain the measurement reports from signal measuring component 208 and can update a measurement report with the measurements. Measurement report generating component 210 can further generate the updated measurement report for providing to one or more base stations for network-initiated handover. In another example, device-initiated handover component 212 can receive the measurements from signal measuring component 208 and can update a neighbor list with the measurements. Device-initiated handover component 212 can determine whether to perform handover of apparatus 200 based in part on the neighbor list and can, in an example, generate a handover message where handover is determined.

In another example, location measuring component 204 can obtain GPS locations of apparatus 200 from GPS component 214. In this example, location change determining component 206 can specify a change in location based on receiving GPS or other satellite-based locations of apparatus 200 in different time periods. For example, the change in location can be an indicator, as described, a numeric value based on a difference computed from the GPS locations, and/or the like. It is to be appreciated that location measuring component 204 can additionally or alternatively measure location of apparatus 200 using other location-assisted methods, such as OTDOA, E-CID, or other terrestrial-based methods.

Moreover, the measurement types can be specified for intra- and/or inter-frequency measurements. For inter-frequency measurements, allowing apparatus 200 to perform more efficient measurements in some cases conserves power and/or processing time since the receiving component 202 RF does not need to be calibrated for the measurements. In addition, measurement type selecting component 110 can select measurement types and/or whether to perform measurements based on whether the neighboring cells operate on different frequencies (e.g., and/or using different RATs), based on a communication mode of the apparatus 200, based on an amount of time available for performing the measurements, and/or the like.

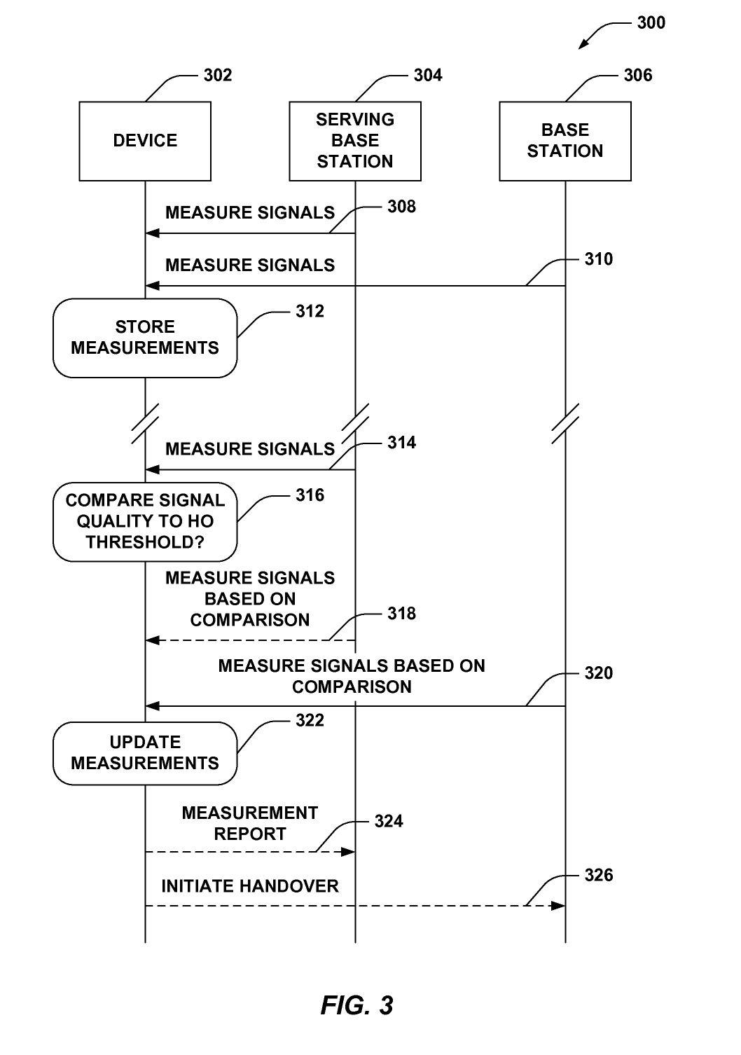

FIG. 3 depicts an example system 300 for measuring cells of various base stations. System 300 includes a device 302 that communicates with a serving base station 304 to receive wireless network access. Device 302 can also measure other base stations, such as base station 306, and/or related cells. Device 302 can measure signals 308 from serving base station 304 and measure signals 310 from base station 306. Device 302 can store the measurements 312. For example, measuring signals 308 and 310 can comprise performing more precise measurements, such as SNR, CINR, etc., which can occur upon initialization of device 302, following handover (or as part of handover) to serving base station 304, and/or the like.

In a subsequent time period—e.g., based on a timer or other event—device 302 can measure signals 314 from serving base station 304 to determine whether device 302 has changed location or is otherwise experiencing modified radio conditions. In one example, measuring signals 314 can include a SNR, CINR, RSSI, or substantially any type of measurement. Device 302 can compare signal quality of base station 304 to a HO threshold 316 to infer the change in location, for example, such as to cause more precise or more efficient measurements of neighboring cells to be performed. Based on the comparison at 316, for example, device 302 can measure signals 318 at serving base station 304 and/or measure signals 320 at base station 306 based on the comparison of the signal quality to the HO threshold. In one example, where the signal quality of serving base station 304 is above the HO threshold, device 302 need not measure signals 310 and can utilize the signal measurement obtained from measuring signals 314. In this example, device 302 can also use a more efficient signal measurement type (e.g., RSSI) for measuring signals 320.

Where the signal quality of serving base station 304 is below the HO threshold, however, device 302 may measure signals 318 using a more precise measurement type than used to measure signals 314. In addition, device 302 can utilize the more precise measurement type to measure signals 320. This allows device 302 to obtain more precise measurements that can be used for determining whether handover communications to base station 306 where the signal quality of serving base station 304 or a cell thereof is below the HO threshold at 316. In any case, device 302 can update measurements at 322. In addition, device 302 may communicate a measurement report 324 to serving base station 304 based on the updated measurements, and/or may initiate handover 326 to base station 306 where a neighbor list updated with the measurements indicates that a signal quality difference between serving base station 304 and base station 306 is at a threshold for performing handover to base station 306.

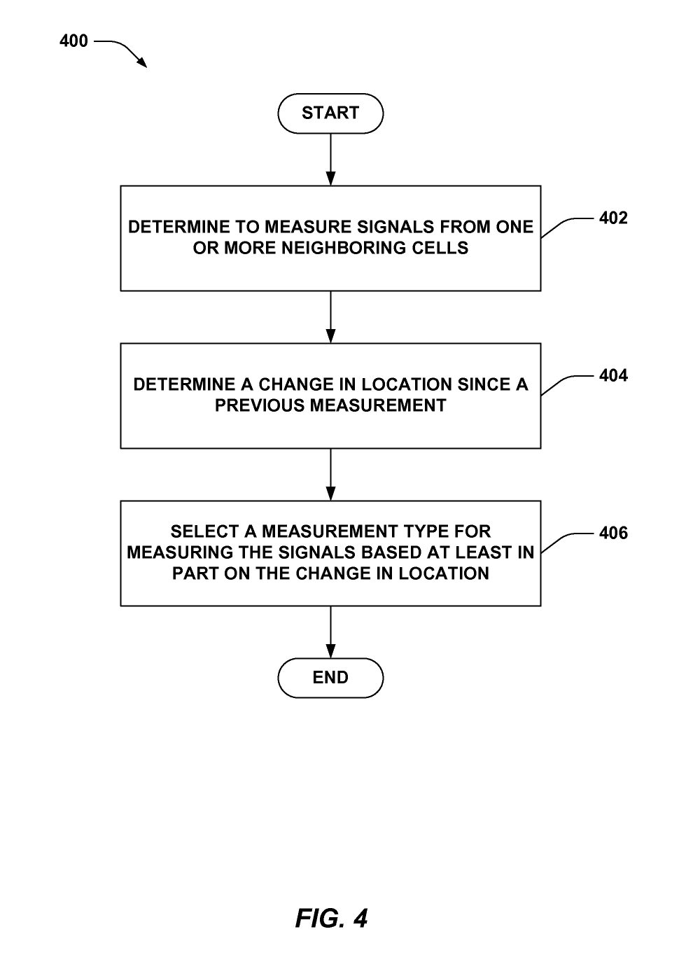

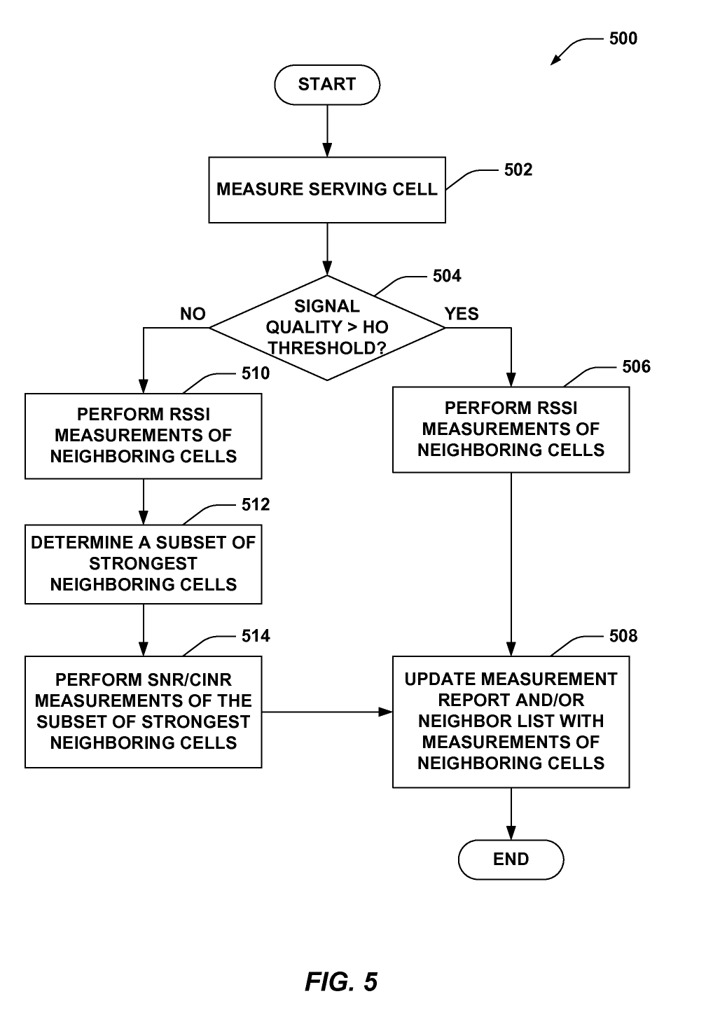

FIGS. 4-5 illustrate example methodologies relating to selecting measurement types for measuring neighboring cells. While, for purposes of simplicity of explanation, the methodologies are shown and described as a series of acts, it is to be understood and appreciated that the methodologies are not limited by the order of acts, as some acts may, in accordance with one or more embodiments, occur concurrently with other acts and/or in different orders from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

FIG. 4 depicts an example methodology 400 for selecting a measurement type for measuring neighboring cells. At 402, it can be determined to measure signals from one or more neighboring cells. For example, this can be part of a handover or other mobility procedure where measurement reports are sent to a serving cell according to a certain schedule, where measurements are to be performed for device-initiated mobility and/or the like. In another example, the determination to measure signals can be based on a received request to measure from one or more network components.

At 404, a change in location can be determined since a previous measurement. In an example, the change in location can correspond to a measured signal quality of a serving cell as compared to a previous measurement, a handover threshold, measurements of one or more neighboring cells, etc. In addition, the change in location can be determined based on a difference in locations received from GPS, OTDOA, E-CID for a current time period and for a time period over which the previous measurement was performed. Moreover, the change in location can be a notification, a value representing a difference between measurements and/or actual location, and/or the like.

At 406, a measurement type can be selected for measuring the signals based at least in part on the change in location. Thus, where the change in location is below a threshold, a more efficient and less precise measurement type, such as RSSI can be selected. Where the change in location is above a threshold, a more precise measurement type, such as SNR, CINR, etc. can be selected. The more precise measurement can utilize RF calibration, at least for inter-frequency measurements, which can leverage additional power and/or time resources. Thus, avoiding such measurements in some cases can conserve device power and/or processing time.

FIG. 5 depicts an example methodology 500 for measuring neighboring cells. At 502, a serving cell can be measured. For example, this can include measuring the serving cell to determine a quality of signals received in the cell. At 504, it can be determined whether the signal quality is greater than a threshold signal quality used to determine to initiate handover. In one example, this can be a DCD HO threshold. If the signal quality is greater than the handover threshold, RSSI measurements of neighboring cells can be performed. This can include measuring RSSI of neighboring cells that operate at different frequencies and/or use different RATs than the serving cell. At 508, a measurement report and/or neighbor list can be updated with the measurements of the neighboring cells. As described, the measurement report can be generated for network-initiated handover, and the measurements in the report related to the neighboring cells can be modified in view of the measurements. Additionally or alternatively, the neighbor list can be stored at a device for device-initiated handover, and measurements in the list related to neighboring cells can be modified in view of the measurements.

If the signal quality is not greater than the handover threshold at 504, RSSI measurements can still be performed of the neighboring cells at 510 for the purpose of determining a subset of strongest neighboring cells at 512. For example, the subset of strongest cells can be determined based in part on at least one of comparing the measured RSSI to a threshold RSSI used to indicate whether the cells are to be measured for the purposes of handover, determining a top n number of cells with highest RSSI, and/or the like. Once the subset of strongest cells is determined, SNR and/or CINR measurements of the subset of strongest neighboring cells can be performed at 514. This can include performing inter-frequency measurements (e.g., where the neighboring cells operate using different RATs) that utilize RF calibration. Since the signal quality of the serving cell is below the handover threshold, more precise measurement of the neighboring cells can be desired to consider the neighboring cells as handover candidates. At 508, a measurement report and/or neighbor list can be updated with measurements of neighboring cells—this can be the subset of strongest neighboring cells, as described.

It will be appreciated that, in accordance with one or more aspects described herein, inferences can be made regarding determining a change in location, selecting a measurement type, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

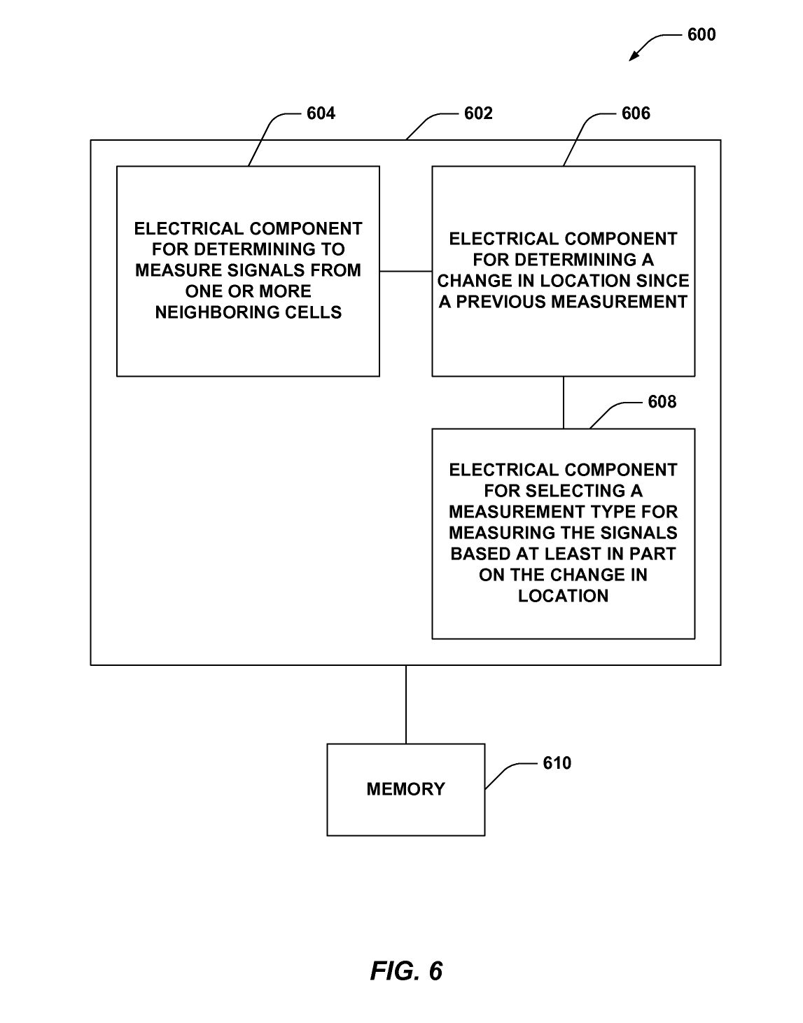

FIG. 6 illustrates a system 600 for determining measurement types for measuring one or more neighboring cells. For example, system 600 can reside at least partially within a device or other receiver. It is to be appreciated that system 600 is represented as including functional blocks, which can be functional blocks that represent functions implemented by a processor, software, or combination thereof (e.g., firmware). System 600 includes a logical grouping 602 of electrical components that can act in conjunction. For instance, logical grouping 602 can include an electrical component for determining to measure signals from one or more neighboring cells 604. For example, the determining can be based on a timer or other event or trigger, etc. Logical grouping 602 can also include an electrical component for determining a change in location since a previous measurement 606.

For example, the change in location can be inferred by comparing a measurement of a serving cell to a HO threshold or to measurements of neighboring cells. In addition, the change in location can be determined by comparing a current location with a previous location (e.g., as obtained by GPS, OTDOA, etc.). Further, logical grouping 602 can include an electrical component for selecting a measurement type for measuring signals based at least in part on the change in location 608. As described, where the change in location is large (e.g., the signal quality of the serving base station is below the HO threshold, a determined location difference is over a threshold, etc.), a more precise measurement type can be selected than where the change in location is not as large. For example, electrical component 604 can include a signal measuring component 208, as described above. In addition, for example, electrical component 606, in an aspect, can include location change determining component 206, as described above. Electrical component 608, in one example, can include measurement type selecting component 110.

Additionally, system 600 can include a memory 610 that retains instructions for executing functions associated with the electrical components 604, 606, and 608. While shown as being external to memory 610, it is to be understood that one or more of the electrical components 604, 606, and 608 can exist within memory 610. In one example, electrical components 604, 606, and 608 can comprise at least one processor, or each electrical component 604, 606, and 608 can be a corresponding module of at least one processor. Moreover, in an additional or alternative example, electrical components 604, 606, and 608 can be a computer program product comprising a computer readable medium, where each electrical component 604, 606, and 608 can be corresponding code.

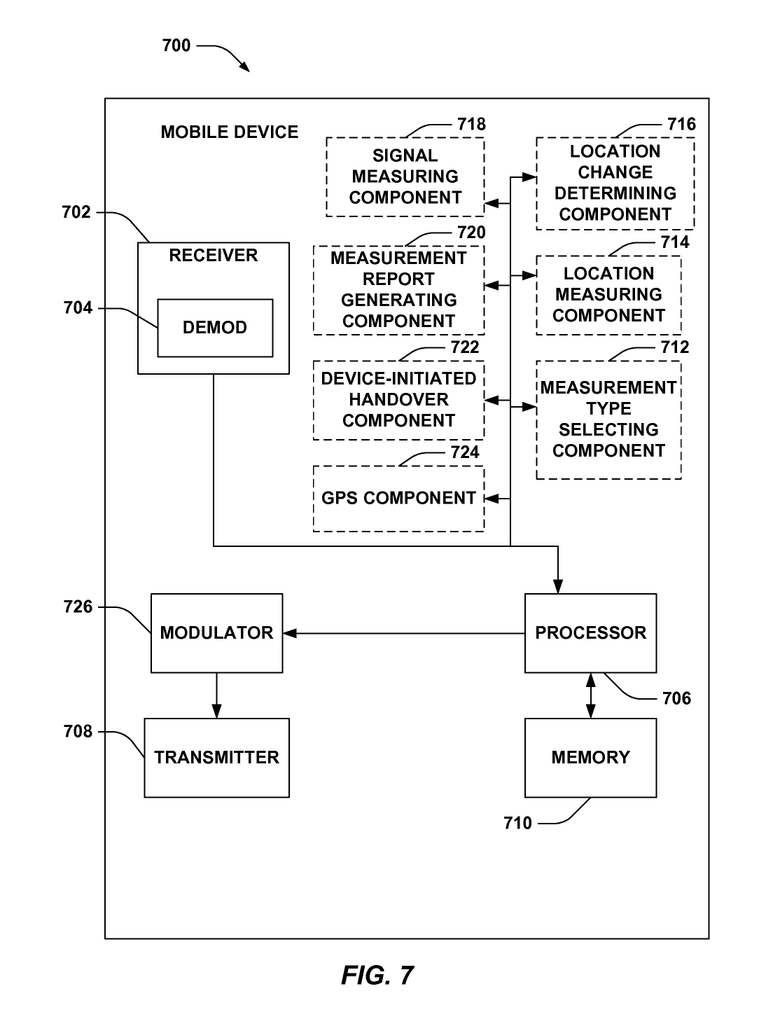

FIG. 7 is an illustration of a mobile device 700 that facilitates selecting measurement types for measuring neighboring cells. Mobile device 700 comprises a receiver 702 that receives a signal from, for instance, a receive antenna (not shown), performs typical actions on (e.g., filters, amplifies, downconverts, etc.) the received signal, and digitizes the conditioned signal to obtain samples. Receiver 702 can comprise a demodulator 704 that can demodulate received symbols and provide them to a processor 706 for channel estimation. Processor 706 can be a processor dedicated to analyzing information received by receiver 702 and/or generating information for transmission by a transmitter 708, a processor that controls one or more components of mobile device 700, and/or a processor that both analyzes information received by receiver 702, generates information for transmission by transmitter 708, and controls one or more components of mobile device 700.

Mobile device 700 can additionally comprise memory 710 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 710 can additionally store protocols and/or algorithms associated with estimating and/or utilizing a channel (e.g., performance based, capacity based, etc.).

It will be appreciated that the data store (e.g., memory 710) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 710 of the subject systems and methods is intended to comprise, without being limited to, these and any other suitable types of memory.

In one example, receiver 702 can be similar to a receiving component 202. Processor 706 can further be optionally operatively coupled to a measurement type selecting component 712, which can be similar to measurement type selecting component 110, a location measuring component 714, which can be similar to location measuring component 204, a location change determining component 716, which can be similar to location change determining component 206, a signal measuring component 718, which can be similar to signal measuring component 208, a measurement report generating component 720, which can be similar to measurement report generating component 210, a device-initiated handover component 722, which can be similar to device-initiated handover component 212, and/or a GPS component 724, which can be similar to GPS component 214.

Mobile device 700 still further comprises a modulator 726 that modulates signals for transmission by transmitter 708 to, for instance, a base station, another mobile device, etc. Moreover, for example, mobile device 700 can comprise multiple transmitters 708 for multiple network interfaces, as described. Although depicted as being separate from the processor 706, it is to be appreciated that the measurement type selecting component 712, location measuring component 714, location change determining component 716, signal measuring component 718, measuring report generating component 720, device-initiated handover component 722, GPS component 724, demodulator 704, and/or modulator 726 can be part of the processor 706 or multiple processors (not shown)), and/or stored as instructions in memory 710 for execution by processor 706.

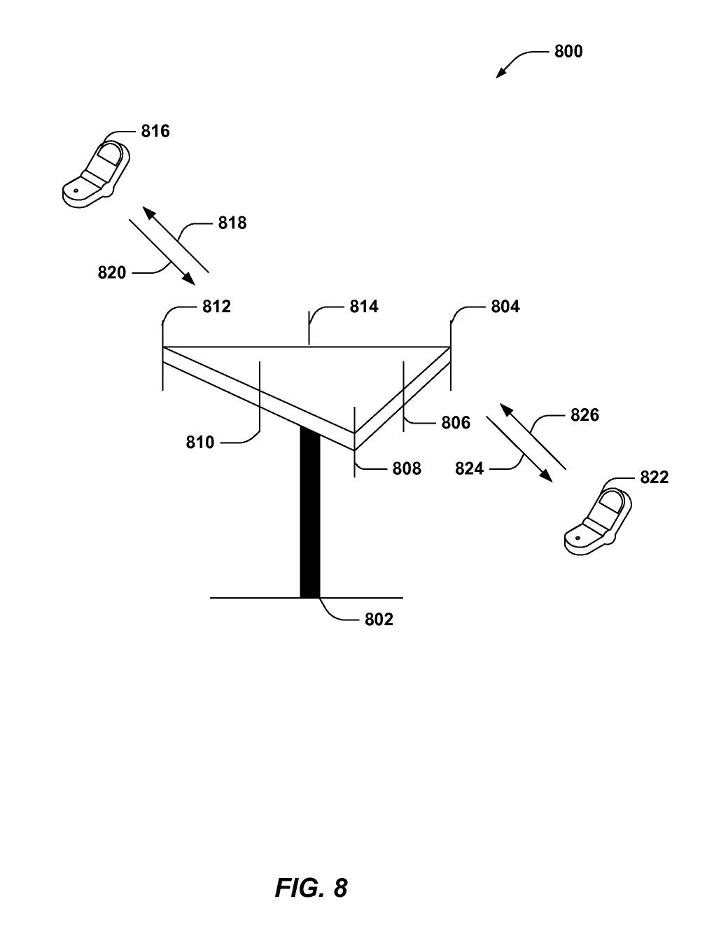

FIG. 8 illustrates a wireless communication system 800 in accordance with various embodiments presented herein. System 800 comprises a base station 802 that can include multiple antenna groups. For example, one antenna group can include antennas 804 and 806, another group can comprise antennas 808 and 810, and an additional group can include antennas 812 and 814. Two antennas are illustrated for each antenna group; however, more or fewer antennas can be utilized for each group. Base station 802 can additionally include a transmitter chain and a receiver chain, each of which can in turn comprise a plurality of components or modules associated with signal transmission and reception (e.g., processors, modulators, multiplexers, demodulators, demultiplexers, antennas, etc.), as is appreciated.

Base station 802 can communicate with one or more mobile devices such as mobile device 816 and mobile device 822; however, it is to be appreciated that base station 802 can communicate with substantially any number of mobile devices similar to mobile devices 816 and 822. Mobile devices 816 and 822 can be, for example, cellular phones, smart phones, laptops, handheld communication devices, handheld computing devices, satellite radios, global positioning systems, PDAs, and/or any other suitable device for communicating over wireless communication system 800. As depicted, mobile device 816 is in communication with antennas 812 and 814, where antennas 812 and 814 transmit information to mobile device 816 over a forward link 818 and receive information from mobile device 816 over a reverse link 820. Moreover, mobile device 822 is in communication with antennas 804 and 806, where antennas 804 and 806 transmit information to mobile device 822 over a forward link 824 and receive information from mobile device 822 over a reverse link 826. In a frequency division duplex (FDD) system, forward link 818 can utilize a different frequency band than that used by reverse link 820, and forward link 824 can employ a different frequency band than that employed by reverse link 826, for example. Further, in a time division duplex (TDD) system, forward link 818 and reverse link 820 can utilize a common frequency band and forward link 824 and reverse link 826 can utilize a common frequency band.

Each group of antennas and/or the area in which they are designated to communicate can be referred to as a sector of base station 802. For example, antenna groups can be designed to communicate to mobile devices in a sector of the areas covered by base station 802. In communication over forward links 818 and 824, the transmitting antennas of base station 802 can utilize beamforming to improve signal-to-noise ratio of forward links 818 and 824 for mobile devices 816 and 822. Also, while base station 802 utilizes beamforming to transmit to mobile devices 816 and 822 scattered randomly through an associated coverage, mobile devices in neighboring cells can be subject to less interference as compared to a base station transmitting through a single antenna to all its mobile devices. Moreover, mobile devices 816 and 822 can communicate directly with one another using a peer-to-peer or ad hoc technology as depicted. According to an example, system 800 can be a multiple-input multiple-output (MIMO) communication system or similar system that allows assigning multiple carriers between base station 802 and mobile devices 816 and/or 822. For example, devices 816 and/or 822 can utilize aspects herein to measure a serving cell provided by base station 802 and/or one or more neighboring cells (not shown).

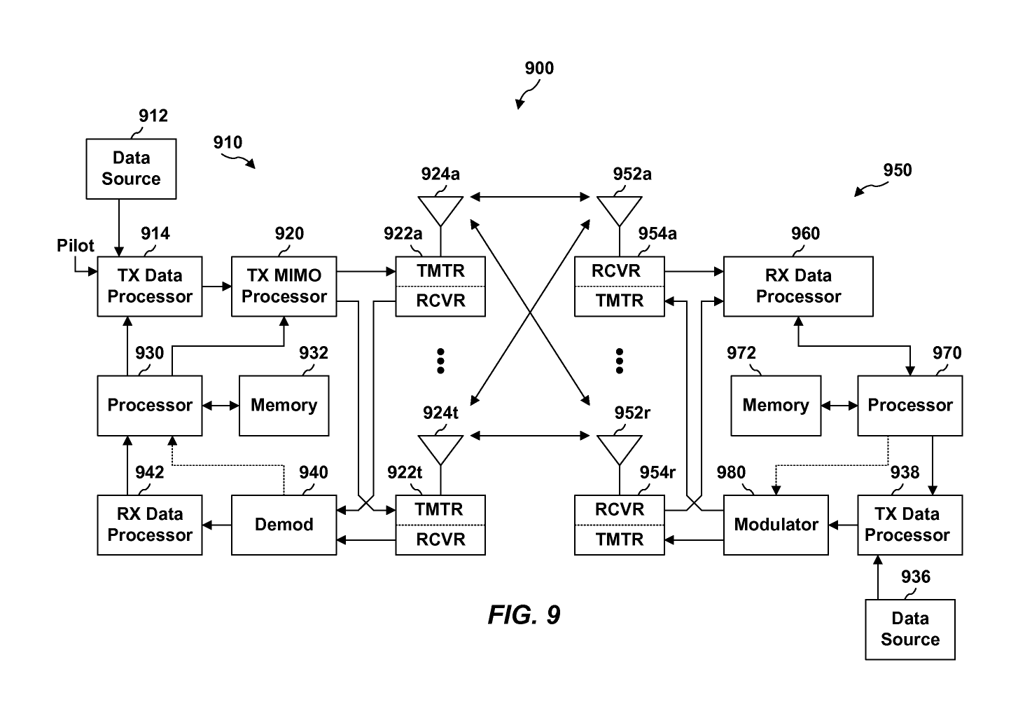

FIG. 9 shows an example wireless communication system 900. The wireless communication system 900 depicts one base station 910 and one mobile device 950 for sake of brevity. However, it is to be appreciated that system 900 can include more than one base station and/or more than one mobile device, wherein additional base stations and/or mobile devices can be substantially similar or different from example base station 910 and mobile device 950 described below. In addition, it is to be appreciated that base station 910 and/or mobile device 950 can employ the systems (FIGS. 1-3, 6, and 8), methods (FIGS. 4-5), and/or mobile devices (FIG. 7) described herein to facilitate wireless communication there between. For example, components or functions of the systems and/or methods described herein can be part of a memory 932 and/or 972 or processors 930 and/or 970 described below, and/or can be executed by processors 930 and/or 970 to perform the disclosed functions.

At base station 910, traffic data for a number of data streams is provided from a data source 912 to a transmit (TX) data processor 914. According to an example, each data stream can be transmitted over a respective antenna. TX data processor 914 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 950 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 930.

The modulation symbols for the data streams can be provided to a TX MIMO processor 920, which can further process the modulation symbols (e.g., for OFDM). TX MIMO processor 920 then provides N_{T} modulation symbol streams to N_{T} transmitters (TMTR) 922a through 922t. In various embodiments, TX MIMO processor 920 applies beamforming weights to the symbols of the data streams and to the antenna from which the symbol is being transmitted.

Each transmitter 922 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 922a through 922t are transmitted from N_{T} antennas 924a through 924t, respectively.

At mobile device 950, the transmitted modulated signals are received by N_{R} antennas 952a through 952r and the received signal from each antenna 952 is provided to a respective receiver (RCVR) 954a through 954r. Each receiver 954 conditions (e.g., filters, amplifies, and downconverts) a respective signal, digitizes the conditioned signal to provide samples, and further processes the samples to provide a corresponding “received” symbol stream.

An RX data processor 960 can receive and process the N_{R} received symbol streams from N_{R} receivers 954 based on a particular receiver processing technique to provide N_{T} “detected” symbol streams. RX data processor 960 can demodulate, deinterleave, and decode each detected symbol stream to recover the traffic data for the data stream. The processing by RX data processor 960 is complementary to that performed by TX MIMO processor 920 and TX data processor 914 at base station 910.

The reverse link message can comprise various types of information regarding the communication link and/or the received data stream. The reverse link message can be processed by a TX data processor 938, which also receives traffic data for a number of data streams from a data source 936, modulated by a modulator 980, conditioned by transmitters 954a through 954r, and transmitted back to base station 910.

At base station 910, the modulated signals from mobile device 950 are received by antennas 924, conditioned by receivers 922, demodulated by a demodulator 940, and processed by a RX data processor 942 to extract the reverse link message transmitted by mobile device 950. Further, processor 930 can process the extracted message to determine which precoding matrix to use for determining beamforming weights.

Processors 930 and 970 can direct (e.g., control, coordinate, manage, etc.) operation at base station 910 and mobile device 950, respectively. Respective processors 930 and 970 can be associated with memory 932 and 972 that store program codes and data. Moreover, processors 930 and 970 can perform selection of a measurement type for measuring signals received from neighboring cells by receivers 922 and 954, as described herein. For example, processors 930 and 970 can execute functions described with respect to such measuring and/or memory 932 and 972 can store such functions and/or data related thereto.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for measuring neighboring cells in wireless communications, comprising:
determining to measure signals from one or more neighboring cells;
determining a change in location since a previous measurement; and
selecting a measurement type for measuring the signals based at least in part on the change in location.

2. The method of claim 1, wherein the selecting the measurement type comprises selecting an efficient measurement type that does not utilize radio frequency (RF) calibration where the change in location is below a threshold.

3. The method of claim 2, wherein the selecting the efficient measurement type comprises selecting a received signal strength indicator measurement type.

4. The method of claim 1, wherein the selecting the measurement type comprises selecting a precise measurement type that utilizes radio frequency (RF) calibration where the change in location is above a threshold.

5. The method of claim 4, further comprising:
measuring at least a portion of the signals using an initial measurement type that does not utilize RF calibration;
determining a subset of the one or more neighboring cells based on the measuring; and
measuring additional signals from the subset of the one or more neighboring cells using the precise measurement type.

6. The method of claim 4, wherein the selecting the precise measurement type comprises selecting a signal-to-noise ratio or carrier-to-interference-and-noise ratio measurement type.

7. The method of claim 1, wherein the determining the change in location comprises comparing a current measurement of a serving cell to a handover threshold.

8. The method of claim 1, wherein the determining the change in location comprises comparing a current location to a previous location at a time of the previous measurement.

9. The method of claim 8, further comprising obtaining the current location and the previous location using a satellite-based or terrestrial-based measurement.

10. The method of claim 1, wherein at least one of the one or more neighboring cells uses a radio access technology different from another radio access technology utilized by another one of the one or more neighboring cells.

11. An apparatus for measuring neighboring cells in wireless communications, comprising:
means for determining to measure signals from one or more neighboring cells;
means for determining a change in location since a previous measurement; and
means for selecting a measurement type for measuring the signals based at least in part on the change in location.

12. The apparatus of claim 11, wherein the means for selecting selects the measurement type as an efficient measurement type that does not utilize radio frequency (RF) calibration where the change in location is below a threshold.

13. The apparatus of claim 11, wherein the means for selecting selects the measurement type as a precise measurement type that utilizes radio frequency (RF) calibration where the change in location is above a threshold.

14. The apparatus of claim 13, wherein the means for determining to measure measures at least a portion of the signals using an initial measurement type that does not utilize RF calibration, determines a subset of the one or more neighboring cells based on the measuring, and measuring additional signals from the subset of the one or more neighboring cells using the precise measurement type.

15. The apparatus of claim 11, wherein the means for determining the change in location compares a current measurement of a serving cell to a handover threshold.

16. An apparatus for measuring neighboring cells in wireless communications, comprising:
at least one processor configured to:
determine to measure signals from one or more neighboring cells;
determine a change in location since a previous measurement; and
select a measurement type for measuring the signals based at least in part on the change in location; and
a memory coupled to the at least one processor.

17. The apparatus of claim 16, wherein the at least one processor selects the measurement type as an efficient measurement type that does not utilize radio frequency (RF) calibration where the change in location is below a threshold.

18. The apparatus of claim 16, wherein the at least one processor selects the measurement type as a precise measurement type that utilizes radio frequency (RF) calibration where the change in location is above a threshold.

19. The apparatus of claim 18, wherein the at least one processor is further configured to:
measure at least a portion of the signals using an initial measurement type that does not utilize RF calibration;
determine a subset of the one or more neighboring cells based on the measuring; and
measure additional signals from the subset of the one or more neighboring cells using the precise measurement type.

20. The apparatus of claim 16, wherein the at least one processor determines the change in location at least in part by comparing a current measurement of a serving cell to a handover threshold.

21. A computer program product for measuring neighboring cells in wireless communications, comprising:
a non-transitory computer-readable medium, comprising:
code for causing at least one computer to determine to measure signals from one or more neighboring cells;
code for causing the at least one computer to determine a change in location since a previous measurement; and
code for causing the at least one computer to select a measurement type for measuring the signals based at least in part on the change in location.

22. The computer program product of claim 21, wherein the code for causing the at least one computer to select selects the measurement type as an efficient measurement type that does not utilize radio frequency (RF) calibration where the change in location is below a threshold.

23. The computer program product of claim 21, wherein the code for causing the at least one computer to select selects the measurement type as a precise measurement type that utilizes radio frequency (RF) calibration where the change in location is above a threshold.

24. The computer program product of claim 23, wherein the computer-readable medium further comprises:
code for causing the at least one computer to measure at least a portion of the signals using an initial measurement type that does not utilize RF calibration;
code for causing the at least one computer to determine a subset of the one or more neighboring cells based on the measuring; and
code for causing the at least one computer to measure additional signals from the subset of the one or more neighboring cells using the precise measurement type.

25. The computer program product of claim 21, wherein the code for causing the at least one computer to determine determines the change in location at least in part by comparing a current measurement of a serving cell to a handover threshold.

26. An apparatus for measuring neighboring cells in wireless communications, comprising:
a signal measuring component for determining to measure signals from one or more neighboring cells;
a location change determining component for determining a change in location since a previous measurement; and
a measurement type selecting component for selecting a measurement type for measuring the signals based at least in part on the change in location.

27. The apparatus of claim 26, wherein the measurement type selecting component selects the measurement type as an efficient measurement type that does not utilize radio frequency (RF) calibration where the change in location is below a threshold.

28. The apparatus of claim 27, wherein the efficient measurement type comprises a received signal strength indicator measurement type.

29. The apparatus of claim 26, wherein the measurement type selecting component selects the measurement type as a precise measurement type that utilizes radio frequency (RF) calibration where the change in location is above a threshold.

30. The apparatus of claim 29, wherein the signal measuring component measures at least a portion of the signals using an initial measurement type that does not utilize RF calibration, determines a subset of the one or more neighboring cells based on the measuring, and measures additional signals from the subset of the one or more neighboring cells using the precise measurement type.

31. The apparatus of claim 29, wherein the precise measurement type comprises a signal-to-noise ratio or carrier-to-interference-and-noise ratio measurement type.

32. The apparatus of claim 26, wherein the location change determining component compares a current measurement of a serving cell to a handover threshold.

33. The apparatus of claim 26, wherein the location change determining component compares a current location to a previous location at a time of the previous measurement.

34. The apparatus of claim 33, further comprising a location measuring component for obtaining the current location and the previous location using a satellite-based or terrestrial-based measurement.

35. The apparatus of claim 26, wherein at least one of the one or more neighboring cells uses a radio access technology different from another radio access technology utilized by another one of the one or more neighboring cells.
